(19) United States
(12) Patent Application Publication
(10) Pub. No.: US 2003/0214933 A1
(43) Pub. Date: Nov. 20, 2003

(54) System and method for single-point to fixed-multipoint data communication

(75) Inventor: Kenneth Margon, Oakland, CA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: Cape Range Wireless Malaysia Sdn, Petaling Jaya (MY)

(21) Appl. No.: 10/462,697

(22) Filed: Jun. 17, 2003

Related U.S. Application Data
(63) Continuation-in-part of application No. 09/482,054, filed on Jan. 13, 2000.

(51) Int. Cl. H04B 7/216

(52) U.S. Cl. 370/342

(57) ABSTRACT

Systems and methods for single-point to fixed-multipoint communication. The invention dynamically allocates bandwidth based on traffic demands, thus providing efficient bandwidth utilization, particularly with bursty or time sensitive data traffic. A system includes a Base Station and a plurality of Remote Stations. The Base Station transmits information to the Remote Stations via a Forward Channel and the Remote Stations transmit information via a Reverse Channel. Before transmitting on the Reverse Channel, each of the Remote Stations listens (monitors) the Reverse Channel to ascertain whether any other Remote Station is transmitting. Remote Stations transmit data only when a Remote Station determines that the channel is clear. The Remote Stations listen in sequential order, eliminating the probability of collisions caused by simultaneous transmissions from Remote Stations. The data traffic is accordingly aggregated, thus providing efficient bandwidth utilization.

### CROSS-REFERENCE TO RELATED APPLICATIONS

The present application is a continuation-in-part of U.S. patent application Ser. No. 09/482,054, filed on Jan. 13, 2000, and is related to U.S. patent application Ser. No. 10/___,___, entitled “Parallel Spread Spectrum Communication System and Method,” filed Jun. 17, 2003. The above-referenced patent applications are hereby incorporated by reference in their entirety.

### BACKGROUND OF THE INVENTION

1. Field of Invention

The present invention relates to data communication, and more particularly, to a method and system for single-point to fixed-multipoint communication.

2. Description of Related Art

In a conventional single-point to fixed-multipoint data communication system, a base station transmits to fixed remote stations and each of the fixed remote stations, in turn, transmit to the base station. Such systems typically use one or more predetermined and typically internationally adopted communication protocols. These protocols tend to be optimized for particular applications and industries. For example, protocols used for wireless communication tend to be developed and influenced by the telecommunication industry. However, since many of these conventional systems that have communication medium interconnecting the base station to the fixed remote stations are terrestrial (e.g., copper or optical fiber medium) the data communication protocols tend to be developed and/or heavily influenced by the computer industry.

A fixed wireless system is generally characterized by a point to multipoint topology where remote stations are fixed at specific locations. Wireless in the Local Loop (WLL) is an example of a point to multipoint topology. Most WLL solutions use a variant one of the major wireless telecommunication protocols such as Frequency Division Multiple Access (FDMA), Time Division Multiple Access (TDMA), or Code Division Multiple Access (CDMA). Systems using these protocols assign and reserve bandwidth for the communication between the remote stations and the base station.

A FDMA-based system assigns a separate channel in an available channel band to each remote station. For instance, in cellular systems these channels are assigned by the base station upon receiving a request for channel from a cellular phone (radio). There is a common channel used for control information that is passed back and forth between the base and remote. A TDMA-based system breaks a channel into time slots. Each remote station is assigned a time slot. If there is no data to be transmitted when the time slot becomes available, the bandwidth is wasted since it is not reallocated to another remote radio. In general, a CDMA-based system uses a non-correlating coding sequence to allow multiple radios to transmit and receive in the same frequency range. In cellular CDMA, a base station assigns a code based on a request from a cell phone. There is a practical limit to the number of codes in use in a sector, thus limiting the number of active channels.

Conventional wireless telecommunication protocols tend to be efficient where there is a continuous flow of information. However, Internet data traffic and modern voice digitizing technology is by its nature bursty in its use of bandwidth. Accordingly, systems using these conventional protocols do not make efficient use of the available channel bandwidth with the bursty data traffic, largely because the assigned channels remain idle whenever their assigned stations are not bursting.

Another drawback associated with existing wireless telecommunications protocols is that they require a base station to communicate and broker bandwidth among a large plurality of remote stations, which causes significant delays. Additionally, these conventional protocols fail to accommodate the various demands of different remote stations at different times because of their inability to dynamically allocate bandwidth based on traffic demand.

Conventional computer-based data communication protocols are typically designed and used for multipoint to multipoint communication. Such protocol are optimized to handle bursty data traffic. Examples of such protocols include Carrier Sense Multiple Access (CSMA) and Carrier Sense Multiple Access/Collision Detection (CSMA/CD) protocols. When optimized, these protocols can make efficient use of the bandwidth. The optimization, however, assumes the multipoint-to-multipoint underlying topology. In addition, because of the lack of channel reservations and due to the inconsistency of burstiness of data traffic, these protocols fail to adequately support time sensitive data traffic, such as digitized voice, at high utilization rate of their bandwidth.

### SUMMARY OF THE INVENTION

The present invention is directed to systems and methods for efficient single-point to fixed-multipoint data (data and/or digitized voice) communication. The invention overcomes the drawbacks of conventional systems and protocols, particularly with respect to applications with bursty or time sensitive data traffic, by dynamically allocating bandwidth based on traffic demands.

In one embodiment, wireless data communication is provided in context of a fixed single point to multipoint system having a Base Station and a plurality of Remote Stations. In operation, the Base Station transmits data packets to the Remote Stations via a Forward Channel and the Remote Stations transmit data packets to the Base Station via a Reverse Channel. Before transmitting on the Reverse Channel, each of the Remote Stations listens to (monitors) the Reverse Channel to ascertain whether any other Remote Station is transmitting. Remote Stations transmit data only when a Remote Station determines that the channel is clear. The Remote Stations listen in sequential order, eliminating the probability of collisions caused by simultaneous transmissions from Remote Stations.

The invention also efficiently and dynamically aggregates data traffic, thus allowing the entire bandwidth to be utilized. For example, when only one of Remote Stations requires bandwidth, the entire bandwidth is allocated to that Remote station. If multiple Remote Stations need bandwidth, the entire bandwidth is allocated according to the needs of those stations. No Remote Station is denied bandwidth nor is bandwidth wasted on a Remote Station that has no data to send with the teaching of the invention. Furthermore, use of the Reverse Channel is achieved without the overhead of brokering and/or a reservation protocol, thereby circumventing associated delays.

Another feature of the invention is that the order in which the Remote Stations listen to the Reverse Channel can be rotated periodically. Thus, equal access for transmission on the Reverse channel is ensured for all Remote Stations.

In another aspect of the invention, Remote Stations are assigned to various zones. Remote Stations in a given zone listen only to other Remote Stations in that zone. This reduces the hardware cost associated with Remote Stations since zones can be configured for those stations within a close geographical proximity of each other. Alternately, Remote Stations can be grouped in zones based on station type, data traffic type, or access rate requirements for the Reverse Channel.

In an embodiment of the invention, a single point to multipoint communications system comprises: a base station capable of providing a forward channel signal; and a plurality of remote stations capable of (i) monitoring the forward channel signal, (ii) monitoring a reverse channel during a clear channel assessment interval, and (iii) transmitting a reverse channel signal when the reverse channel is clear; wherein the plurality of remote stations are distributed among at least two zones including a first zone and a second zone, the first zone of remote stations monitoring the reverse channel during a first clear channel assessment interval and the second zone of remote stations monitoring the reverse channel during a second clear channel assessment interval. The forward and reverse channel signals can implement signals including parallel spread spectrum.

In another embodiment of the invention, a method for a single-point to a fixed multi-point system having a base station and a plurality of remote stations distributed among at least two zones including a first zone and a second zone comprises the steps of: transmitting from the base station a forward channel signal; monitoring for the forward channel signal at each of the plurality of remote stations; monitoring a reverse channel at each of the first zone of remote stations during an exclusively assigned dwell time within a first clear assessment interval; and monitoring a reverse channel at each of the second zone of remote stations during an exclusively assigned dwell time within a second clear assessment interval; if the reverse channel is clear during a dwell time exclusively assigned to a first remote station and the first remote station has information to send to the base station, transmitting a reverse channel signal from the first remote station.

Another feature of the invention is its ability to be layered with other protocols such as a parallel spread spectrum communication protocol.

In an embodiment of the invention, a multiple access communication system, comprises: a base station that provides a forward channel signal; and a plurality of remote stations, wherein each remote station monitors the forward channel signal, monitors a reverse channel within an assigned period of time in a clear channel assessment interval, and provides a reverse channel signal when the reverse channel is clear within the assigned period of time, wherein the forward and reverse channel signals comprise parallel spread spectrum communication signals.

An advantage of the present invention is that it provides an Internet Protocol Multiple Access (iPMA) management protocol that maximizes the potential and economics of Internet Protocol (IP) and bandwidth without compromising telephone voice quality. The present invention allows simultaneous transmission from both Remote Stations and a Base Station independently, so it is well suited to handle the asymmetrical data requirement of Internet users downloading web pages to their personal computers.

Another advantage of the present invention is that it guarantees stable latency for data communications, which is not possible with standard IP. This means that extra bandwidth does not have to be reserved to handle the probability that multiple users will need to transmit at the same time since the timing of data packets is coordinated.

Yet another advantage of the invention is that it does not require the use of a transmission reservation protocol or brokering system to allocate bandwidth to remote stations.

The present invention is designed for coverage over a wide area compared to mobile cellular protocols that are designed for high teledensity deployment over short distances.

In addition, embodiments of the invention are more efficient than CDMA. For example, a CDMA cellular system carries 30 simultaneous phone conversations in one cell sector using only one correlating code. The same system employing the Internet Protocol Multiple Access technique of the present invention can carry 240 simultaneous phone conversations.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a topological view of a single-point to fixed-multipoint wireless data communication system in accordance with the invention;

FIGS. 2A and 2B, respectively, are high level views of a half-duplex and a full-duplex system using a Forward Channel and Reverse Channel in accordance with the invention;

FIG. 3 is a detailed view of a Forward Channel, a Reverse Channel, and a Clear Channel Assessment phase in accordance with the invention;

FIG. 4 is a detailed view of a successive series of Forward Channel, Reverse Channel, and Clear Channel Assessment occurrences with Dwell Time rotation in accordance with the invention;

FIG. 5 illustrates a topological view of a single-point to fixed-multipoint wireless data communication system split into multiple zones in accordance with the invention;

FIG. 6 is a detailed view of a successive series of Forward Channel, Reverse Channel, and Clear Channel Assessment occurrences in accordance with the invention;

FIG. 7 illustrates a control packet in accordance with the invention; and

FIG. 8 illustrates a process for adding a new Remote Station to a network in accordance with the invention.

### DETAILED DESCRIPTION OF THE PREFERRED EMBODIMENTS

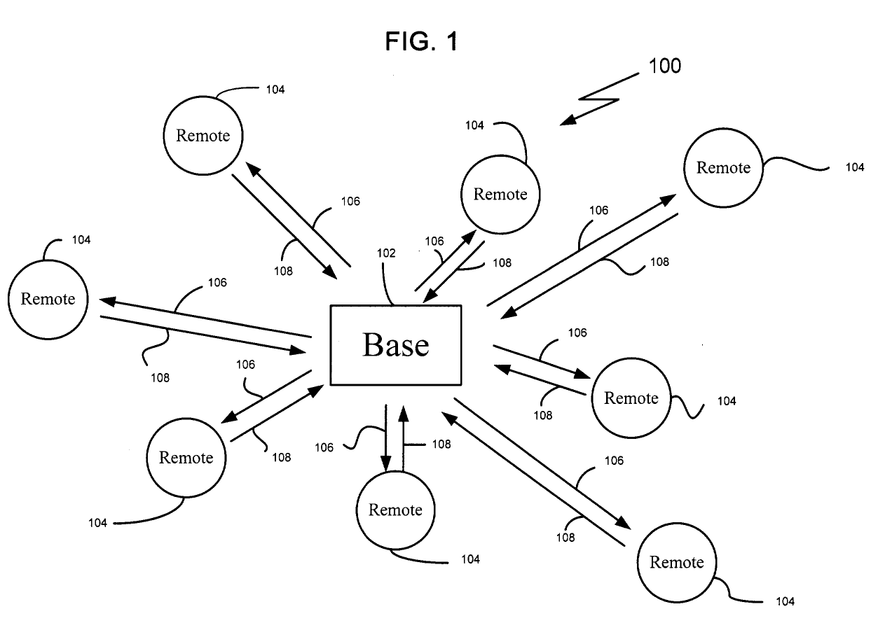

Preferred embodiments of the present invention and their advantages may be understood by referring to FIGS. 1-8, wherein like reference numerals refer to like elements, and are described in the context of a single-point to multipoint fixed wireless data communication system employing an Internet Protocol (IP) addressing scheme. Nonetheless, the invention can be practiced in any type of single-point to fixed multipoint system as would be apparent to one of ordinary skill in the art. For example, the teachings of the invention can be used in a non-wireless communication medium, such as a copper-based, fiber optics-based, or hybrid-coax based communication medium. One such embodiment of the invention can be a local area network having a single-point to fixed-multipoint topology. The invention provides information (e.g., data and digitized voice) for a wide range of Internet applications (e.g., e-mail, web browsing, etc.). For example, a single-point station can provide Internet connectivity services to various fixed-multipoint stations to enable users at these multipoint stations to send and receive e-mail, connect with the World Wide Web, or establish digitized voice communications.

FIG. 1 is a topological view of a single-point to fixed-multipoint wireless data communication network system 100 in accordance with the invention. System 100 includes a Base Station 102 and a plurality of Remote Stations 104. The Base Station 102 can be connected to the Internet, legacy phone system, or any other conventional network (not shown). Each Remote Station 104, in turn, can be connected to multiple destination devices (not shown) and/or subscribers (not shown). Communication from and to the Base Station 102 and each of the Remote Stations 104 is provided over a Forward Channel (FC) 106 and a Reverse Channel (RC) 108, respectively. In a preferred embodiment, FC 106 and RC 108 are modulated over carrier radio frequency (RF) signals in the 2 GHz frequency range implementing a parallel spread spectrum communications protocol as described in U.S. patent application Ser. No. 10,075,367, entitled “Parallel Spread Spectrum System and Method”, the entire disclosure of which is incorporated herein by reference. Parallel spreading comprises encoding and spreading a data stream using orthogonal Walsh functions, and thereby segmenting the data stream into multiple bit data packets representing one of a number of true or inverted Walsh codes. The data stream is then differentially encoded for either BPSK or QPSK modulation, and spread using a PN-sequence. The parallel spread data stream is modulated for transmission to a receiver. At the receiver, the data stream is recovered by computing a cross correlation between the digitized data stream and a programmed sequence. Implementation of such enables wireless communication distances of up to approximately 50 km. As would be apparent to one skilled in the art, other types of communication techniques and carrier signals can be readily utilized with the invention.

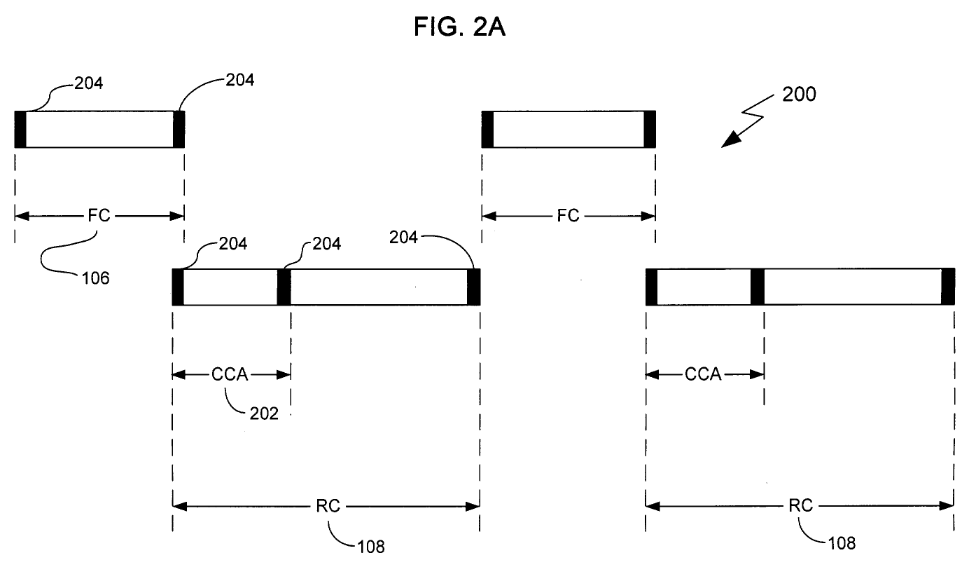

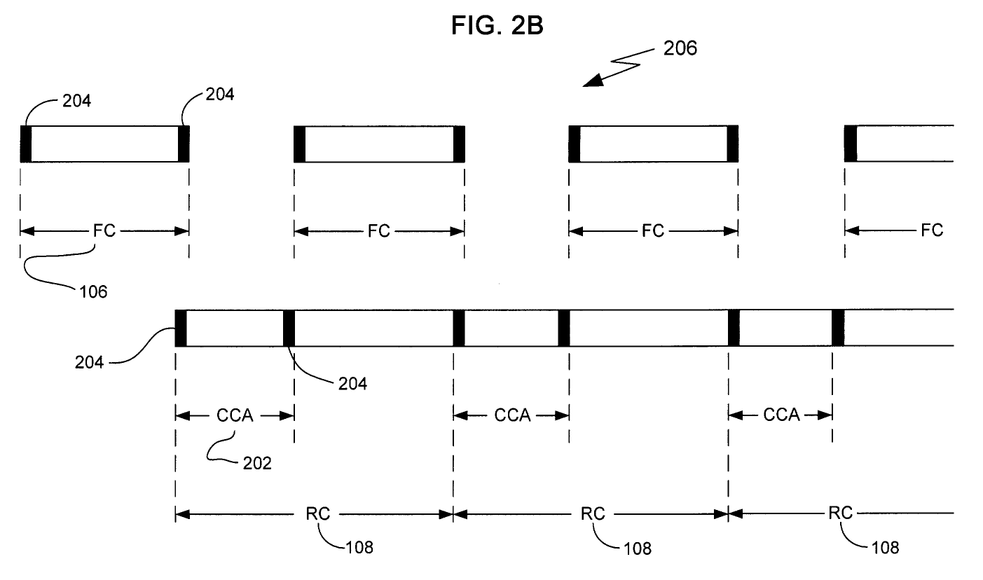

The communication between Base Station 102 and each Remote Station 104 can be conducted in half- or full-duplex embodiments. FIG. 2A is a high level view of a half-duplex embodiment 200 of the invention. In this embodiment, Base Station 102 first transmits to each Remote Station 104 via FC 106. During this time interval, each Remote Station 104 tunes (switches) to the frequency of FC 106 and receives data packets (or data packet) transmitted by Base Station 102. The time interval allotted for FC 106 is based, in part, on the time requirements for Base Station 102 to transmit (or burst) data and each Remote Station 104 to receive the data.

Base Station 102 can dynamically communicate with Remote Stations 104 in a number of different addressing schemes. For example, for each FC 106, data packet can be destined for a specific Remote Station 104, all Remote Stations 104, or a subset (pre-assigned group) thereof. Data packets destined for a specific Remote Station are marked by a unique address that is assigned a priori to each Remote Station 104. In such an instance, each Remote Station 104 detects FC 106, but only the Remote Station with a matching address will process the received data and the remaining Remote Stations 104 will discard the transmitted data packets. Data packets destined to all Remote Stations 104 are marked by a broadcast address. Upon detection of FC 106, each Remote Station 104 will recognize the broadcast address and process the received data. Data packets destined for a subset of Remote Stations 104 are marked by a special address, thereby providing a semi-broadcast type of communication.

The foregoing addressing scheme of the invention can be readily mapped into higher level protocols, such as the widely used Internet Protocol (IP). In such an embodiment, the address of each Remote Station 104 can correspond to the IP address of that Remote Station 104. Alternatively, the Remote Station IP address itself can be used directly within the addressing scheme of embodiments of the invention. The advantage of this later embodiment is the elimination of added complexity of mapping and the easier interface to the Internet, or other IP networks, via the Base Station 102. Moreover, in such IP embodiments, existing higher level networking communication software and hardware can be utilized with the invention. For instance, data packets that are meant to be sent to all Remote Stations 104 can use the default addressing broadcast scheme of IP. These types of data packets can include control data that can be used for overall system management, provisioning, control, or merely to broadcast user information to the Remote Stations 104. Data packets that are meant to be sent to a specific Remote Station 104 will have the IP address of that specific station. Accordingly, only that specific Remote Station will unpack that data packet at its networking layer while all other Remote Stations 104 will simply discard that packet. Another advantage of using the IP protocol as an addressing scheme is the ability to create zones that correspond to one or more sub-networks of the IP network. Accordingly, such embodiments of the invention can be configured so that a subset of the Remote Stations 104 exist in one IP sub-network or zone.

Returning to FIG. 2A, once the time allotted for FC 106 has expired, each Remote Station 104 switches to the frequency of RC 108 and enters into a Clear Channel Assessment (CCA) 202 phase. During this time, each Remote Station 104 listens to RC 108 to ascertain whether other Remote Stations 104 are transmitting. If a first Remote Station, e.g., a station having the highest transmission priority, which has data packets to send to Base Station 102, ascertains that none of the other Remote Stations 104 are transmitting, the first Remote Station transmits its data packets to Base Station 102 until the time allotted for RC 108 expires. Since each Remote Station 104 listens to all transmissions originating from any other Remote Stations 104, each Remote Station 104 detects the transmission of the first Remote Station and refrains from transmitting. Further discussion of these features of the invention is provided below. Once the time allotted for RC 108 expires, all Remote Stations 104 switch their listening frequency again to re-tune to FC 106 and Base Station 102 begins to transmit another occurrence of FC 106 to Remote Stations 104.

In accordance with the invention, each Remote Station 104 thereby determines whether or not to transmit data (by monitoring the RC 108). In this regard, the embodiments of the invention do not require Base Station 102 to broker or provide access to RC 108 among Remote Stations 104. Accordingly, any propagation delay associated with the brokering is circumvented.

To facilitate the requisite handshaking and low error rate communication between Base Station 102 and Remote Stations 104, these stations are synchronized. Methods for synchronizing communication systems are well known in the art and can be readily employed with the embodiments of this invention. For example, synchronization can be achieved during the initial configuration of system 100 and can be maintained by broadcast control packets transmitted from Base Station 102.

The invention also provides Guard Times (GT) 204 to accommodate for delays associated with embodiments thereof and to optimize each embodiment to specifications of that embodiment (e.g., extremely low error rate, minimized synchronization time, etc.). As noted before, the invention can be practiced, with various applications, topologies, and station designs. Each embodiment will require the compensation for propagation delays associated with FC 106 and RC 108 transmissions (a function of the distance between the stations) and delays associated with the circuitry (hardware), processing, and frequency switching of the stations. Conventional techniques are available to calculate or measure such delay times.

In the present embodiment, GT 204 are placed at the beginning and end of FC 106, RC 108 and CCA 202. Other GT 204 arrangements, however, can be used to accommodate for aforementioned and other delays. For example, an embodiment of the invention can have GT 204 placed at the beginning and at the end of FC 106, at the end of RC 108, and at the end CCA 202.

FIG. 2B is a high level view of a full-duplex embodiment 206 of the invention. The main difference between this embodiment and the aforementioned half-duplex embodiment is that the transmission of FC 106 overlaps with the transmission of RC 108. In a preferred embodiment, the transmission of FC 106, however, does not occur during the CCA 202 phase of RC 108. Accordingly, the transmission of FC 106 begins after the expiration of the time allotted for the CCA 202 phase. As illustrated, FC 106 can last for a period that equals the time remaining for the RC transmission 108. As with half-duplex embodiments of the invention, full-duplex embodiments can utilize GT 204 to accommodate for various delays.

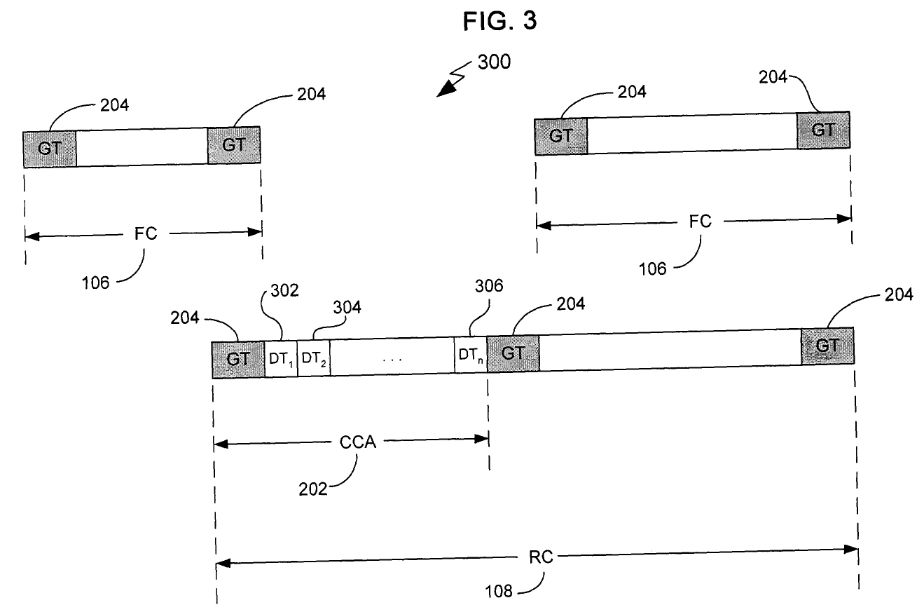

FIG. 3 is a detailed view of FC 106, RC 108, and CCA 202 and illustrates the operation of a full-duplex embodiment of the invention 300. Initially, Remote Stations 104 are tuned to listen to the frequency of FC 106. After the time allotted for FC 106 expires, each Remote Station 104 re-tunes to the frequency of RC 108 and begins to listen to this channel. This marks the beginning of the CCA 202 phase.

CCA 202 is divided into periods of time, Dwell Time (DT) of equal time duration. However, other embodiments of the invention can use DT of various time durations. As illustrated, there are “n” DT periods (e.g., DT₁, 302, DT₂, 304, up to DTₙ 306). In general, each Remote Station 104 is dynamically assigned a particular DT period and listening occurs in a serial manner. Each Remote Station 104 listens to RC 108 during its designated DT and if during its DT the channel clear, that station can transmit data. More specifically, during the CCA 202 phase, each Remote Station 104 waits until its assigned DT to listen RC 108. A first Remote Station (e.g., a Remote Station designated an identification (ID) of one) with DT₁ 302 listens first to RC 108. After the expiration of DT₁ 302, a second Remote Station (e.g., a Remote Station designated with an ID of two) listens to RC 108 for the period of DT₂ 304. Similarly, an “n^{th}” Remote Station waits until the beginning of DTₙ 306 to listen to RC 108 for that DT period. A Remote Stations that has data to send to Base Station 102 does so only when that Remote Station has listened to RC 108, at its designed DT, and has ascertained that no other Remote Station 104 is transmitting (i.e., that a clear channel exists). In the above example, if the first Remote Station has no data to send, that station spends DT₁ 302 listening to RC 108 and does no transmission (even if a clear channel exists).

The second Remote Station starts to listens to RC 108, at DT₂ 304, and assesses whether or not a clear channel condition is met. The channel is clear if the preceding Remote Station (i.e., the first Remote Station) did not have any data and no other station (e.g., an “n^{th}” Remote Station) has had the opportunity to transmit yet. If the second Remote station does not have data to transmit, it listens to RC 108 during DT₂ 304 without any transmission over RC 108 in the same fashion as the first Remote Station. If, however, the second Remote Station does have data to transmit it does so over RC 108 immediately after the station assesses that a clear channel is present. In accordance with the invention, the second Remote Station will transmit all its data during the time allotted for this occurrence of RC 108 or until the RC expires. Once DT₂ 304 has expired, and during DTₙ 306, the “n^{th}” Remote Station begins to listen to RC 108 and detects that the second Remote Station is still transmitting data. Accordingly, the “n^{th}” Remote Station assesses that RC 108 is not a clear channel (busy) and does not transmit any data (if it had any) during this particular RC 108 period.

In order to ensure that all Remote Stations 104 have equal opportunity to transmit data to Base Station 102, the order of DT (e.g., 302, 304, and 306) can be changed during successive RC occurrences. Otherwise, Remote Stations 104 with a low order DT (in this example, the first and second Remote Stations) would always have a higher priority to send data than Remote Stations with a higher order DT (in this example, the “n^{th}” Remote Station). Schemes for dynamically allocating the DTs can be preconfigured in each Remote Station 104 so that the Base Station 102 does not waste valuable processing resources and time managing such. Nonetheless, the Base Station 102 can send a control packet to overrule the preconfigured dynamic allocation scheme or reset the DT order to a new order.

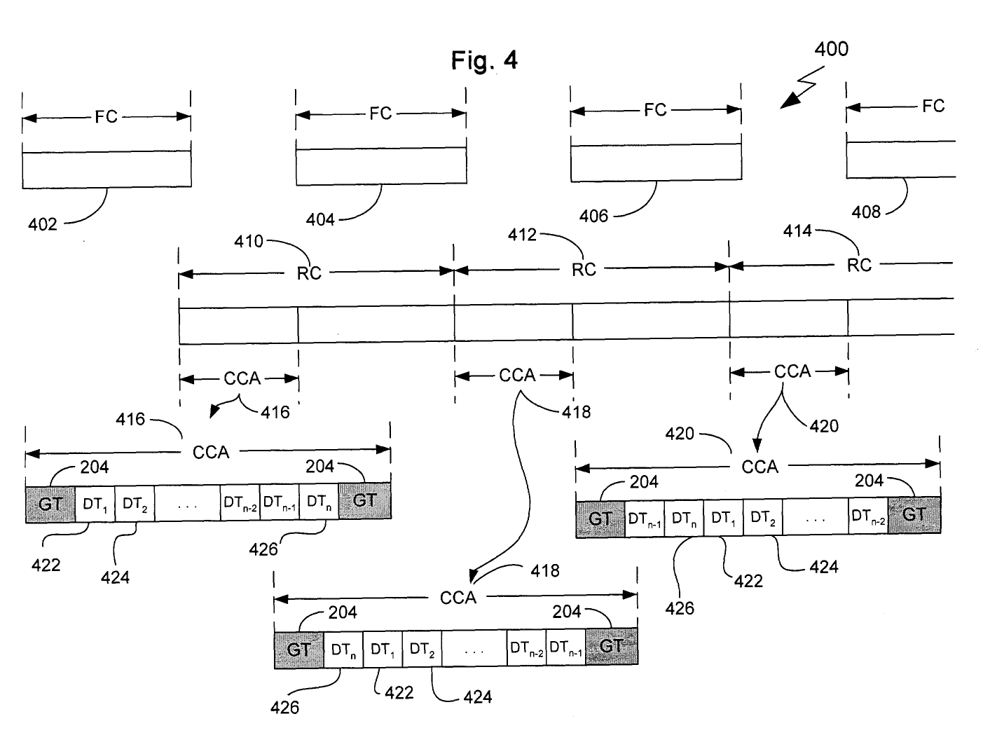

FIG. 4 is a detailed view of a series of FC (402, 404, 406, 408), RC (410, 412, 414), and CCA (416, 418, 420) occurrences with DT rotation, in a full-duplex embodiment 400 of the invention. After FC 402 and at the beginning of RC 410, a first Remote Station listens to the channel during DT₁ 422. Next, a second Remote Station listens during DT₂ 424 and finally an “n^{th}” Remote Station listens during DTₙ 426. The DT are then rotated in a round robin fashion for the next RC occurrence (RC 412). As illustrated, during RC 412, the Remote Station that listened last (in this example, the “n^{th}” Remote Station) will listen first, as its DT, 426 is shifted to the beginning of CCA 418. The other Remote stations DT are shifted to occur later in time by a period equal to DTₙ. Over time of the operation the rotation provides each Remote Station 104 with an equal opportunity to transmit data. As would be apparent to one skilled in the art, assignment and the changing of DT order can readily be achieved with other algorithms other than the round robin scheme illustrated. Equal access to the bandwidth is an important feature for those embodiments that support time sensitive traffic or require small and consistent delays. For instance, voice over IP requires not only small delays, but also consistent delay, because large variations of delay tend to cause jitter. Moreover, embodiments of the invention can be implemented with other DT structures. For example, one or more Remote Stations can be assigned a predetermined and fixed DT slot while other Remote Stations are undergoing rotation. With such embodiments, priority to certain Remote Stations can be achieved.

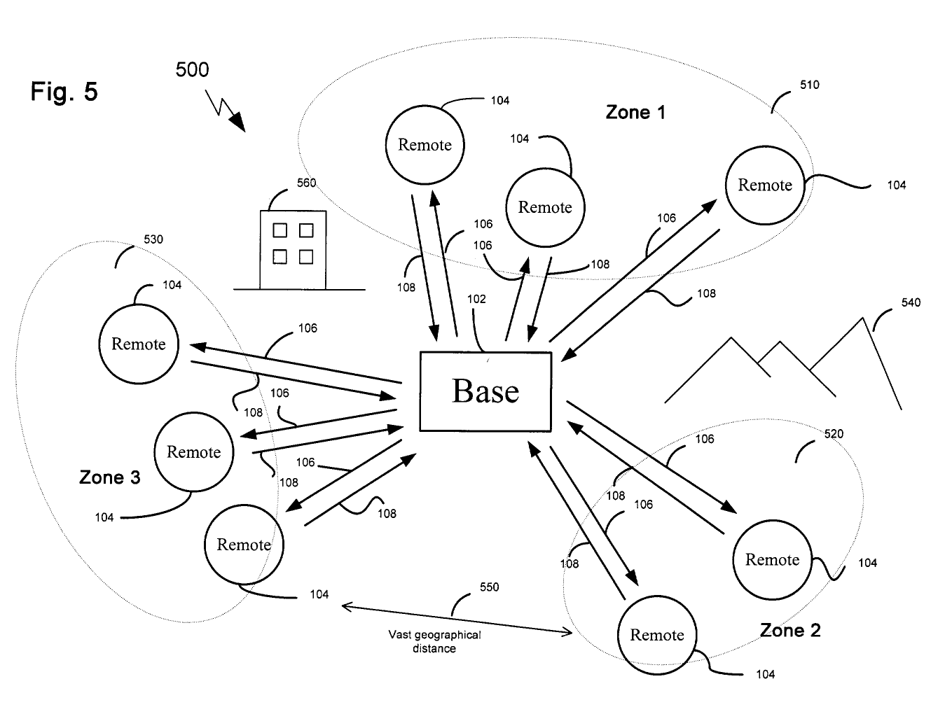

As noted above, the invention can be practiced with multiple zones. FIG. 5 illustrates a three zone network system 500, the specified number of which is exemplary only, grouped according to physical location. For example, network system 500 comprises a first zone 510, Zone 1; a second zone 520, Zone 2; and a third zone 530, Zone 3. Each zone groups a number of Remote Stations 104 located in a given physical region. Remote Stations 104 are zoned in such a way to prevent Remote Stations of different zones from communicating with each other. Usually this is dictated by terrain between zones, e.g., mountains 540 between Zone 1 and Zone 2; vast distances between zones that are greater than the maximum communication distance between Remote Stations, e.g., a vast distance 550 between Zone 2 and Zone 3; or an interfering structure prohibiting communication between zones, e.g., a building 560 between Zone 3 and Zone 1. Zoning is particularly useful in rural settings where one Base Station 102 can serve sparsely located villages comprising one or more tightly grouped Remote Stations 104.

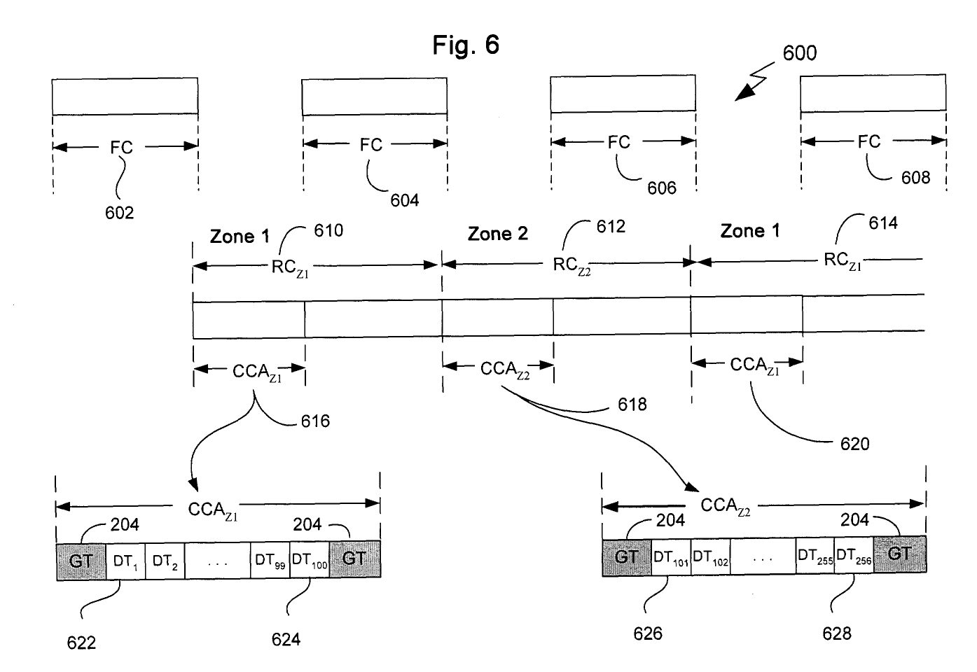

FIG. 6 is a detailed view of a series of FC (602, 604, 606, 608), RC (610, 612, 614), and CCA (616, 618, 620) in a two-zone (Zones 1 and 2) system 600 in accordance with the invention. In this embodiment, Remote Stations 104 assigned ID addresses 1 through 100 are configured in Zone 1 and Remote Stations assigned ID address 101 through 256 are configured in Zone 2. Remote Stations, in Zone 1, transmit at a first occurrence of a Reverse Channel (in this instance, RC 610). Remote Stations, in Zone 2, transmit at a second occurrence of the Reverse Channel (in this instance, RC 612). Thereafter, Remote Stations, in Zone 1, transmit again at the following occurrence of a Reverse Channel (in this instance, RC 614) and so forth. In this preferred embodiment, Remote Stations within a given zone only listen to the Remote Stations in their zone.

In this preferred embodiment, the changing of the DT order occurs independently in each zone and the rotation scheme disclosed above is utilized. Accordingly, DT associated with Remote Stations in Zone 1 (in this instance, DT₁ 622 through DT₁₀₀ 624) are rotated at each Reverse Channel in which Zone 1 Remote Stations can transmit (in this instance, RC 610 and RC 614). Correspondingly, DT associated with Remote Stations in Zone 2 (in this instance, DT₁₀₁ 626 through DT₂₅₆ 628) are rotated at each Reverse Channel occurrence such stations are assigned to transmit (in this instance, RC 612).

The use of zones allows for the grouping of those Remote Stations that are in close physical proximity to each other. The transmission hardware (e.g., antennas) of Remote Stations is thus kept at a minimum because each Remote Station only has to listen to those Remote Station in its assigned zone. In addition, such embodiments of the invention allow the maintenance of a single Base Station 102 in a spacious geographical area while minimizing the cost of the hardware at the Remote Stations 104 due to their grouping in zones of smaller geographic areas. Increased efficiency is achieved by moving intelligence to the Remote Stations so that propagation delays to the base station do not reduce system throughput. For example, if Remote Stations are at a distance of 50 km from the Base Station, but are zoned into areas where the distance between Remote Stations is no more than 10 km apart, 96.8 percent of the bandwidth is available for voice and data payloads assuming 640 subscribers located in 10 Remote Stations. In a zone having 1920 subscribers located in 30 Remote Stations, 84.2 percent of the bandwidth is available for data. In a suburban environment where Remote Stations in each zone are no greater than 5 km apart, 91.4 percent of the bandwidth is available for payload with 1920 subscribers located in 30 Remote Stations.

Alternatively, Remote Stations can be grouped in zones that correspond to a type of service. Because the changing of DT occurs for each zones independently, those zones having fewer Remote Stations have a higher access rate for each of their Remote Stations. For instance, Zone 1 in FIG. 6 has 100 Remote Stations while Zone 2 has 156 Remote Stations. Thus, the DT of each Remote Station in Zone 1 is rotated at a faster rate than DT of a Remote Station in Zone 2. Accordingly, Remote Stations at Zone 1 will have a higher overall access rate than Remote Stations in Zone 2.

It would be apparent to one skilled in the art that the configuration of zones and their corresponding addresses is a matter of network design, and the methods used are well known in the art. For example, a class-C IP sub-network can be assigned to a single zone with embodiments of the invention. Alternately, IP masking can be used to assign smaller or larger IP sub-networks to zones in such embodiments.

In an embodiment of the invention, data awaiting transmission from a Remote Station 104 via the Reverse Channel 108 is prioritized by type of data. For example, an algorithm is implemented at each Remote Station 104 to prioritize the type of data transmitted during its available transmission time. In an exemplary embodiment of the invention, data is divided into three types: voice data, control data, and Internet data. Because voice data is extremely time sensitive, it is given the highest priority for transmission. Control data is given the next highest transmission priority and any Internet data, e.g., e-mail of HTTP traffic, is given the lowest transmission priority.

As recognized above, an initial configuration process of the single point to fixed multipoint systems 100 and 500 is implemented to calibrate communications between the Base Station 102 and the Remote Stations 104. This is important, particularly upon the addition of a new Remote Station to an existing network where distance between stations, e.g., the distance between the Base Station 102 and a new Remote Station and the distances between the existing Remote Stations 104 and the new Remote Station, is essential to factoring in RF propagation delays. By measuring the distance between the Base Station 102 and the newly added Remote Station, the rollover time can be measured and calibrated accordingly. By measuring the distances between the Remote Stations 104 and the newly added Remote Station, an optimum dwell time period for the network zone can be determined. Prior to the start of such a configuration phase, the Base Station 102 sends a broadcast control packet including provisioning information and other parameters, such as default dwell time duration, to all existing Remote Stations 104 and the newly added Remote Station.

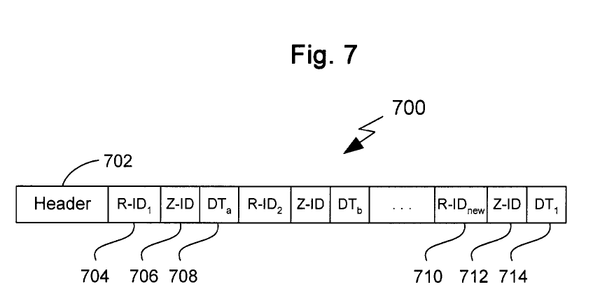

FIG. 7 illustrates an exemplary format of a broadcast control packet 700. Broadcast control packet 700 comprises a header 702, which includes one or more instructions, e.g., instructing all Remote Stations 104 to enter into a configuration phase to add a new Remote Station, and the length of broadcast control packet 700. Following the header 702, multiple data fields are provided pertaining to each Remote Station 104. In an exemplary embodiment of the invention, three data fields are associated with each Remote Station 104. For example, a first field 704, R-ID₁, designates the ID or address of a first Remote Station 104; a second field 706, Z-ID, designates the zone of that first Remote Station, which is particular useful in the case where Remote Station IDs or addresses are repeated between zones; and a third field 708, DTₐ, designating the dwell time, DT, assigned to that first Remote Station. Each subsequent existing Remote Station 104 in the network is provided with similar information in corresponding data fields. The last three fields 710, 712, and 714 correspond to the ID or address, zone, and the assigned dwell time slot, DT₁, which is the first dwell time 302 in the CCA phase 202, for the newly added Remote Station. If multiple zones are not present in the network, then fields 706 and 712 can be omitted. In an embodiment of the invention, the failure to include these three fields with respect to a particular Remote Station indicates to that Remote Station its temporary or permanent removal from the network.

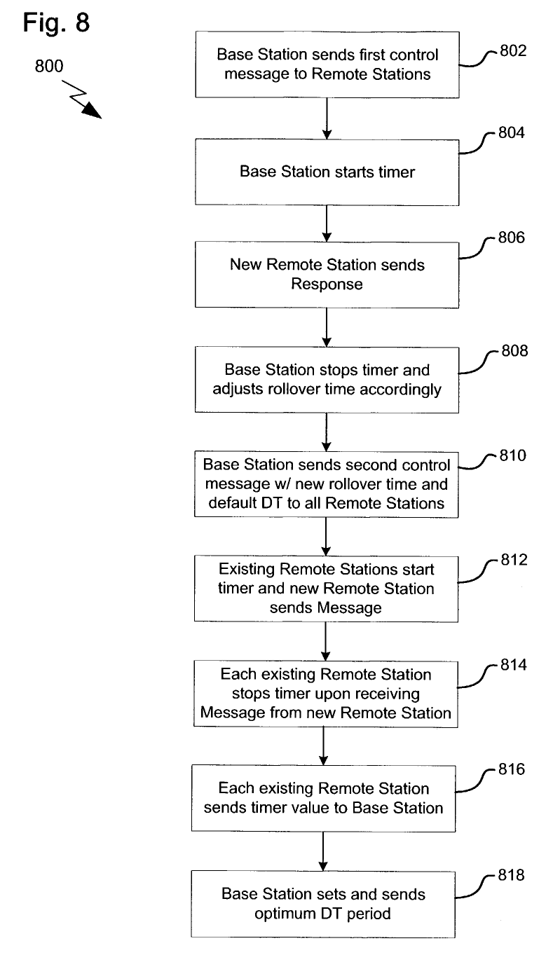

FIG. 8 illustrates a process 800 for configuring a network 100 or zone in network 500 when a new Remote Station is added. Particularly, the Base Station 102 sends (step 802) a broadcast control packet 700 on the Forward Channel to all Remote Stations 104 and the newly added Remote Station instructing them to enter a first configuration phase. During this phase, the newly added Remote Station is assigned the first dwell time, DT₁, and no other Remote Stations 104 are allowed to capture this slot. From the second slot, DT₂, onward, all the existing Remote Stations 104 may communicate with the Base Station 102 as usual. During the first dwell time, the Base Station 102 waits for a period of time that is long enough to accommodate the maximum possible radius of the network (with the Base Station 102 at the center). At substantially the same time the Base Station 102 ends its transmission on the Forward Channel (before the beginning of DT₁), it starts (step 804) a timer. Upon the new Remote Station receiving the broadcast control packet 700, it processes it and sends (step 806) a response to the Base Station 102 on the Reverse Channel. When the new Remote Station's response is received, the Base Station 102 stops its timer. The value of the Base Station 102 timer, T_{base}, is equal to twice the time it takes an RF signal to travel between the Base Station 102 and the new Remote Station and the time it takes the new Remote Station to process the control message 700, i.e.,

T_{base}=2·t_{new}+P

where t_{new} is the time it takes the RF signal to travel one-way between the Base Station 102 and the new Remote Station, and P is the time is takes the new Remote Station to process the broadcast control packet 700. Because T_{base} is measured and P is known (by experiment or theoretical calculation) for all Remote Stations 104, t_{new} can be determined from the above equation. The distance between the Base Station 102 and the new Remote Station is calculated by multiplying t_{new} by the speed of light. By doing this, the rollover time can be adjusted accordingly, the implementation of which is apparent to one of ordinary skill in the art.

Base station 102 then sends (step 810) the adjusted rollover time in a second broadcast control packet to all Remote Stations in the Forward Channel of the next available communications cycle. In this second broadcast control packet, the new Remote Station is still assigned the first dwell time, DT₁; all Remote Stations are instructed to enter a second phase of the configuration process 800, during which the Remote Stations 104 behave as follows and cease normal communication until the configuration is completed; and the length of all dwell times is set to a default length ensuring that all Remote Stations 104 will be able to hear the new Remote Station. For example, the default length of the dwell time is equal to the maximum possible communication distance between remote stations, e.g., 50 km, divided by the speed of light. In this second phase, each Remote Station 104 starts (step 812) a timer at the expiration of the rollover time period. At the same time, the new Remote Station sends a signal to all of the other Remote Stations 104. Upon the reception of this signal, each Remote Station 104 stops (step 814) its timer and then sends (step 816) the timer value to the Base Station 102 when the Reverse Channel is available. Based on all the timer values received, the Base Station determines the maximum time value sent, i.e., the time it took to receive the message at the Remote Station 104 furthest away from the new Remote Station, and sets (step 818) the length of the DTs in subsequent communication cycles to at least this value. This ensures that every Remote Station 104 during it assigned dwell time is able to detect Reverse Channel activity from the new Remote Station.

Other embodiments and uses of the invention will be apparent to those skilled in the art from consideration of the specification and practice of the invention disclosed herein. Although the invention has been particularly shown and described with reference to several preferred embodiments thereof, it will be understood by those skilled in the art that various changes in form and details may be made therein without departing from the spirit and scope of the invention as defined in the appended claims.

What is claimed is:

1. A single point to multipoint communications system comprising:
a base station capable of providing a forward channel signal; and
a plurality of remote stations capable of (i) monitoring said forward channel signal, (ii) monitoring a reverse channel during a clear channel assessment interval, and (iii) transmitting a reverse channel signal when said reverse channel is clear;
wherein said plurality of remote stations are distributed among at least two zones including a first zone and a second zone, said first zone of remote stations monitoring said reverse channel during a first clear channel assessment interval and said second zone of remote stations monitoring said reverse channel during a second clear channel assessment interval.

2. The system of claim 1, wherein said forward and reverse channel signals are wireless channel signals.

3. The system of claim 2, wherein said wireless channel signals are parallel spread spectrum signals.

4. The system of claim 1, wherein said forward and reverse channels signals comprise wired channel signals.

5. The system of claim 1, wherein said first and second zones are geographically separated.

6. The system of claim 1, wherein said base station is capable of receiving information encoded on said reverse channel and wherein said remote stations are capable of receiving information encoded on said forward channel.

7. The system of claim 6, wherein said information includes digitized voice and data.

8. The system of claim 7 wherein said remote stations each comprise a means for prioritizing a transmission of said digitized voice over said data.

9. The system of claim 1, wherein said remote stations are assigned an IP address.

10. The system of claim 1, wherein said first clear channel assessment interval includes dwell times and wherein each of said first zone of remote stations monitors said reverse channel during an exclusively assigned one of said first clear channel assessment interval dwell times.

11. The system of claim 10, wherein said second clear channel assessment interval includes dwell times and wherein each of said second zone of remote stations monitors said reverse channel during an exclusively assigned one of said second clear channel assessment interval dwell times.

12. The system of claim 11, wherein said first clear channel assessment interval dwell times and second clear channel assessment interval dwell times are independently rotated in a round-robin fashion.

13. The system of claim 1, wherein said forward channel signal is provided during a predetermined forward channel interval and said reverse channel signal is provided during a predetermined reverse channel interval.

14. The system of claim 1, wherein said forward channel signal and reverse channel signal are full-duplex signals.

15. A method for a single-point to a fixed multi-point system having a base station and a plurality of remote stations distributed among at least two zones including a first zone and a second zone, the method comprising the steps of:
transmitting from said base station a forward channel signal;
monitoring for said forward channel signal at each of said plurality of remote stations;
monitoring a reverse channel at each of said first zone of remote stations during an exclusively assigned dwell time within a first clear assessment interval;
monitoring a reverse channel at each of said second zone of remote stations during an exclusively assigned dwell time within a second clear assessment interval;
if said reverse channel is clear during a dwell time exclusively assigned to a first remote station and said first remote station has information to send to said base station, transmitting a reverse channel signal from said first remote station.

16. The method of claim 15, wherein said forward and reverse channel signals are wireless channel signals.

17. The method of claim 15, wherein said first and second zones are geographically separated.

18. The method of claim 15, wherein said reverse channel signal includes digitized voice and data.

19. The method of claim 18, further comprising the step of
prioritizing a transmission of said digitized voice over said data.

20. The method of claim 18, wherein said remote stations are assigned an IP address.

21. The method of claim 15, wherein said first and second clear channel assessment intervals each comprise multiple dwell times and further comprising the step of
independently rotating in a round-robin fashion said multiple dwell times of said first clear channel assessment interval and said multiple dwell times of said second clear channel assessment interval.

22. The method of claim 15, wherein said forward channel signal and reverse channel signal are full-duplex signals.

23. The method of claim 15, further comprising the step of assigning a unique remote station address to each of the plurality of remote stations.

24. A multiple access communication system, comprising:
a base station that provides a forward channel signal; and
a plurality of remote stations, wherein each remote station monitors said forward channel signal, monitors a reverse channel within an assigned period of time in a clear channel assessment interval, and provides a reverse channel signal when said reverse channel is clear within said assigned period of time, wherein said forward and reverse channel signals comprise parallel spread spectrum communication signals.

25. The system of claim 24, wherein said forward channel signal and said reverse channel signal include data packets.

26. The system of claim 25, wherein said data packets include digitized voice and data.

27. The system of claim 24, wherein said forward channel includes an address.

28. The system of claim 27, wherein said address is a broadcast address.

29. The system of claim 27, wherein said address is a semi-broadcast address.

30. The system of claim 27, wherein said address is an Internet Protocol address.

31. The system of claim 24, wherein one remote station is assigned a first remote station address from a first set of addresses and a second remote station is assigned a second remote station address from a second set of addresses.

32. The system of claim 24, wherein said first set of addresses form a first zone and said second set of addresses form a second zone.

33. The system of claim 24, wherein each remote station is assigned a remote station address from a set of addresses and said set of addresses form an Internet sub-network.

34. The system of claim 24, wherein said assigned period of time is a predetermined dwell time and wherein each of said remote stations monitor said clear assessment channel interval during said predetermined dwell time.

35. The system of claim 34, wherein each of said dwell times is of equal duration.

36. The system of claim 35, wherein each remote station is dynamically assigned a dwell time.

37. The system of claim 36, wherein said dwell times are assigned to said plurality of remote stations in a round robin fashion.

38. The system of claim 24, wherein said forward channel signal is provided during a predetermined forward channel interval and said reverse channel signal is provided during a predetermined reverse channel interval.

39. The system of claim 38, further comprising guard times among said forward channel interval, said reverse channel interval, and said clear channel assessment interval.

40. The system of claim 39, wherein said guard times are positioned at the beginning and end of said forward channel interval, said reverse channel interval, and said clear channel assessment interval.

41. The system of claim 39, wherein said guard times are positioned at the beginning and end of said forward channel interval and at the end of said reverse channel interval and said clear channel assessment interval.
